(19) United States
(12) Patent Application Publication
(10) Pub. No.: US 2013/0346353 A1
(43) Pub. Date: Dec. 26, 2013

(54) APPARATUS AND METHOD FOR PROVIDING COLLABORATION SERVICE BASED ON COMPOSITE BEHAVIOR

(71) Applicant: Electronics and Telecommunications Research Institute, Daejeon (KR)

(72) Inventors: Youngho SUH, Daejeon (KR); Kang-Woo LEE, Daejeon (KR); Hyun KIM, Daejeon (KR)

(21) Appl. No.: 13/922,817

(22) Filed: Jun. 20, 2013

(30) Foreign Application Priority Data
Jun. 22, 2012 (KR) 10-2012-0067635
Nov. 7, 2012 (KR) 10-2012-0125535

(51) Int. Cl. G06N 5/02

(52) U.S. Cl. CPC G06N 5/02
USPC 706/46

(57) ABSTRACT

An apparatus for generating a collaboration application includes a state chart configured to have tasks for a variety of states; and a coordinator configured to provide a collaboration service using a collaboration application, wherein the collaboration application comprises a task connected to composite behavior of a tree structure and a state to perform the tasks, the tree structure having a parent behavior and a child behavior on a basis of the state chart.

### RELATED APPLICATIONS

This application claims the benefit of Korean Patent Application No 10-2012-0067635, filed on Jun. 22, 2012, and Korean Patent Application No. 10-2012-0125535, filled on Nov. 7, 2012 which are hereby incorporated by references as if fully set forth herein.

### FIELD OF THE INVENTION

The present invention relates to a collaboration service; and more particularly, to an apparatus and method for providing a collaboration service, which is capable of modeling and performing collaboration based on behavior so that a service robot collaborates with devices in an environment to give a user with high level services.

### BACKGROUND OF THE INVENTION

A smart environment means a technology in which ubiquitous devices such as sensors, actuators, digital equipments, and legacy system disposed in a physical space are interlocked to form a virtual space, thereby providing service for residents' convenience.

A service robot recognizes a user's situation or intention in a system of the smart environment and carries out mediation that provides a collaboration service produced by combining and reconstructing available resources in the space.

In order that such a service robot provides a suitable collaboration service as a mediator between a smart environment and a user, following functions should be considered for a robot controlling construction and system.

First, there should be prepared a model for a unit-behavior to perform a unit collaboration service and a performance structure therefor.

Next, there should be prepared a model for composite behavior to provide a high level collaboration service and a performance structure therefor, in order that a goal suitable to each situation is accomplished by combining and planning unit behaviors.

Finally, there should be provided a system in which a robot can perform a collaboration service in a smart home environment based on the modeled collaboration services.

### SUMMARY OF THE INVENTION

In view of the above, the present invention provides a method for generating composite behavior in which a plurality of unit behaviors is connected in a tree structure, capable of recognizing a user's situation or intention.

Further, the present invention provides an apparatus for generating a collaboration application, capable of generating a collaboration application based on composite behavior.

Further, the present invention provides an apparatus for providing a collaboration service, capable of providing a collaboration service suitable for a user's situation using a collaboration application based on composite behavior.

In accordance with an exemplary embodiment of the present invention, there is provided a method for generating composite behavior for a collaboration service, which includes: connecting unit behaviors in a tree structure to generate the composite behavior, wherein each unit behavior in the composite behavior has an event processing functionality that propagates a received event to a child behavior and parent behavior in the tree structure.

In the embodiment, the event processing functionality includes: a filtering that does not propagate the event, an interpretation that interprets the event and aggregates the event to another type of event containing the aggregated result to propagate, or an aggregation that combines one or more events received and aggregates the received events into other type of event to propagate.

In the embodiment, the unit behaviors in the tree structure are configured to execute sequentially or simultaneously.

In accordance with another aspect of the exemplary embodiment of the present invention, there is an apparatus for generating a collaboration application, which includes: a state chart configured to have tasks for a variety of states; and a coordinator configured to provide a collaboration service using a collaboration application, wherein the collaboration application comprises a task connected to composite behavior of a tree structure and a state to perform the tasks, the tree structure having a parent behavior and a child behavior on a basis of the state chart.

In the embodiment, the coordinator is configured to receive events input to the composite behavior through the task connected to the composite behavior, thereby recognizing a user's intention or situation.

In the embodiment, the coordinator is configured to search for a state in the state chart and a task corresponding to the state in accordance with the recognized intention or situation of the user, and connect the searched task to a composite behavior corresponding thereto.

In accordance with another aspect of the exemplary embodiment of the present invention, there is an apparatus for providing a collaboration service, which includes: a collaboration management unit configured to manage a plurality of collaboration policies whose task element is composite behavior of a tree structure and execute a collaboration application by parsing at least one of the plurality of collaboration policies; and a collaboration execution unit configured to construct a state chart in which a state is given to each task when the collaboration application is executed, execute a task corresponding to the state in the state chart, and execute the composite behavior in the collaboration policy given to the task from parent behavior of the highest level to a child behavior of the lowest level, thereby providing the collaboration service.

In the embodiment, the collaboration management unit includes: a policy storage that stores the plurality of collaboration policies having different identifiers; a policy parser configured to load and parse at least one of collaboration policies stored in the policy storage; and a policy factory configured to generate a collaboration coordinator for executing a collaboration application for the parsed collaboration policy based on the identifier of the parsed collaboration policy.

In the embodiment, the collaboration coordinator constructs the state chard and recognizes a user's intention or situation by receiving an event that is input to the composite behavior through the task and state.

In the embodiment, wherein the collaboration coordinator is configured to stop the task that is being executed in accordance with the recognised user's intention or situation, search for a state and a task in the state chart, and execute the searched task.

In the embodiment, the collaboration coordinator searches for a state and a task in the state chart in accordance with the user's intention or situation recognized, and executes composite behavior that is given to the searched task.

By implanting the apparatus and method for generating a collaboration service in the service robot, the service robot can collaborate with devices in a smart environment and provide a collaboration service suitable to a user's context.

### BRIEF DESCRIPTION OF THE DRAWINGS

The above and other objects and features of the present invention will become apparent from the following description of the embodiments given in conjunction with the accompanying drawings, in which:

FIG. 1 is a diagram used to explain a concept of a collaboration service in accordance with an exemplary embodiment of the present invention;

FIG. 2 is a diagram used to explain a composite structure of composite behavior in accordance with an exemplary embodiment of the present invention;

FIGS. 3A to 3D are diagrams used to explain an event processing functionality in a composite behavior structure in accordance with an exemplary embodiment of the present invention;

FIG. 4 is a block diagram of an apparatus for generating a collaboration application, capable of generating a variety of collaboration services using a collaboration model based on composite behavior in accordance with an exemplary embodiment of the present invention;

FIG. 5 is a block diagram of an apparatus for providing a collaboration service in accordance with an exemplary embodiment of the present invention; and

FIG. 6 is a flowchart illustrating a method for providing a collaboration service in accordance with an exemplary embodiment of the present invention.

### DETAILED DESCRIPTION OF THE EMBODIMENTS

The advantages and features of embodiments and methods of accomplishing the present invention will be clearly understood from the following described description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims.

In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may foe made on a basis of the content throughout the specification.

Hereinafter, the embodiments of the present invention will be described in detail with reference to the accompanying drawings so that they can be readily implemented by those skilled in the art.

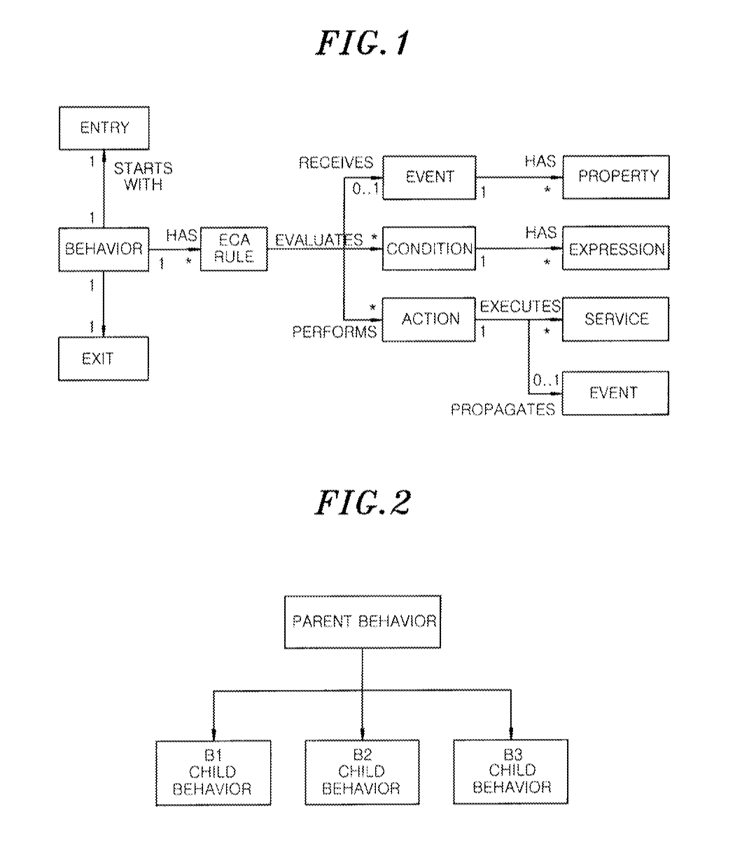

FIG. 1 is a diagram used to explain a concept of a collaboration service in accordance with an exemplary embodiment of the present invention.

The collaboration service performs an entry function, Entry, once when behavior begins, and reactively operates until the end in line with a plurality of Event-Condition-Actions (EGA).

Meanwhile, when the collaboration service receives an event provided thereto, it evaluates a conditional expression constructed of attribute values of the event. Depending on an evaluation result of the conditional expression, an actuator service provided by a smart environment or a robot is performed, or an action is taken in a method of propagating an event. Finally, an end function, Exit, is performed once at the end.

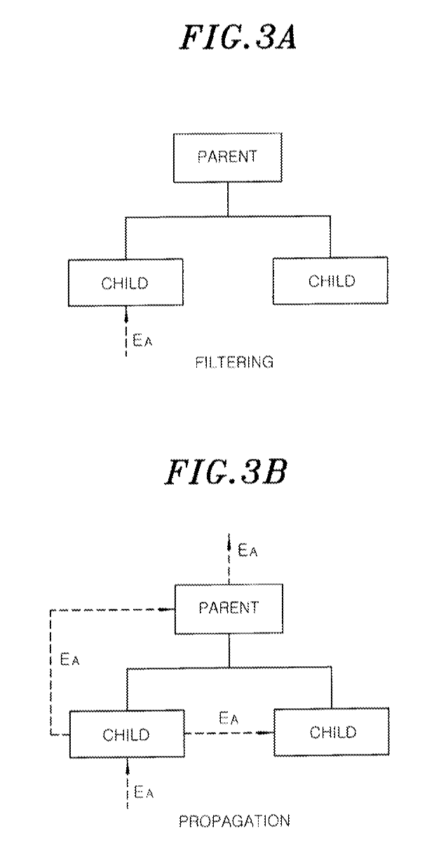

Composite behavior having a composite structure to model a high level collaboration on the basis of such a concept of collaboration service will be described with reference to FIG. 2.

FIG. 2 is a diagram used to explain a composite structure of composite behavior in accordance with an exemplary embodiment of the present invention.

Referring to FIG. 2, composite behavior is constructed in a tree structure, and each free may be constructed of nodes corresponding to the composite behaviors, that is, a plurality of child behaviors connected to parent behavior.

Meanwhile, although not shown, each child behavior may include a plurality of child behaviors belonging thereto.

The composite behavior formed in such a tree structure is divided into two combinations of sequential execution and simultaneous execution. In case of the sequential execution, child behaviors are executed sequentially. In case of the simultaneous execution and the child behaviors are generated, performed and ended simultaneously.

That is, in case of the sequential execution, child behaviors, B1, B2 and B3 are generated, performed and ended in order. In case of the simultaneous execution, child behaviors B1, B2 and B3 are generated, performed and ended at the same time.

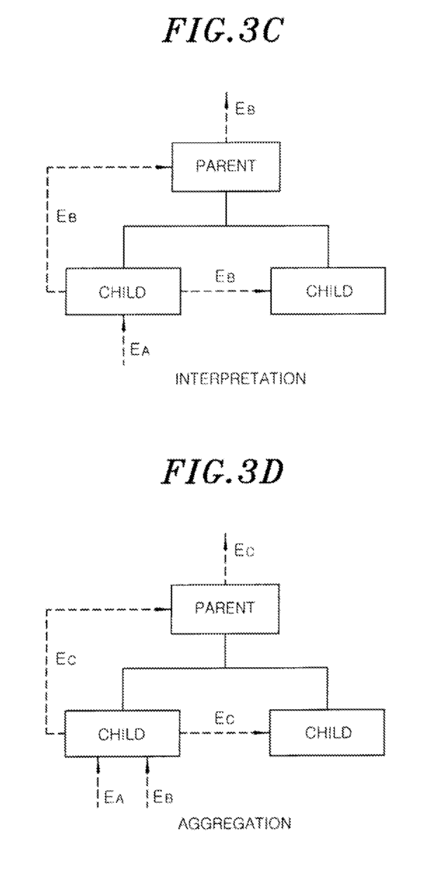

Each behavior in such composite behavior may include an event processing functionality that can propagate event transferred from the outside, for example, sensors or other actions, which will be described with reference to FIGS. 3A to 3D.

FIGS. 3A to 3D are diagrams used to explain an event processing functionality in a composite behavior structure in accordance with an embodiment of the present invention.

According to a rule of event processing functionality, an event propagated by a certain action can be propagated to parent behavior and all sibling behaviors. That is, it is a structure in which the event is backpropagated from a lower part of the tree to a higher part.

Such an event processing functionality may include a filtering, propagation, interpretation and aggregation.

First, the filtering means that the service does not propagate an event Ea any more or the service forbids an event received as shown in FIG. 3A and the propagation means that the service propagates the event Ea to sibling behavior and parent behavior as shown in FIG. 3B. In this case, the sibling behavior and parent behavior that received the event Ea propagate the event Ea to its higher route or a sibling behavior on the relevant route.

As shown in FIG. 3C, the interpretation means that the service interprets the transferred event Ea, aggregates the event Ea into another type of event Eb containing the interpreted result to propagate. The aggregation means that the service combines one or more events Ea and Eb, and aggregates them into another type of event Ec to propagate as shown in FIG. 3D.

Using such event propagation method, a variety of low level events occurring at low level behaviors can be interpreted as high level events that become more abstractive and can be transferred to a higher behavior of the tree.

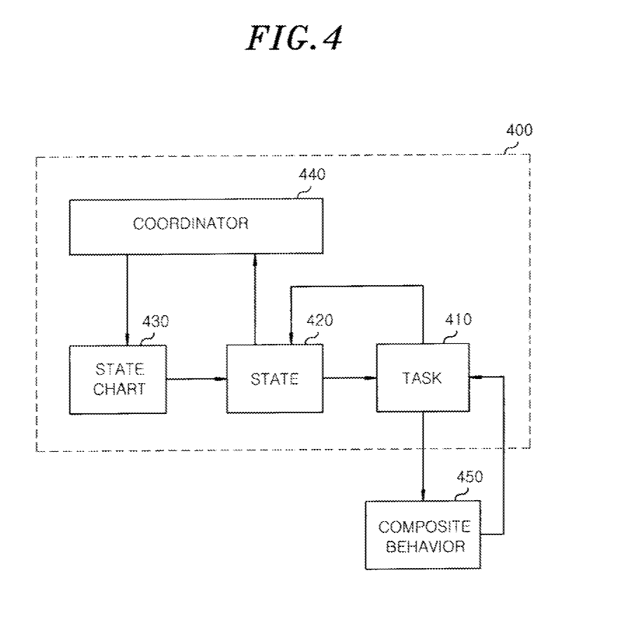

A collaboration application model that can generate a variety of collaboration services using a collaboration model based on composite behavior in accordance with an exemplary embodiment of the present invention will be described with reference to FIG. 4.

FIG. 4 is a block diagram of an apparatus for generating a collaboration application, capable of generating a variety of collaboration services using a collaboration model based on composite behavior in accordance with an exemplary embodiment of the present invention

Referring to FIG. 4, a collaboration application generation apparatus 400 generates a collaboration application constructed of one or sore tasks 410 and a coordinator 440 that schedules the task 410 based on a state chart 430. Here, the task 410 means a goal to be performed in line with the state 420, and the collaboration application is connected to a composite behavior 450 to perform the task 410.

Further, the state chart 430 stores the task 410 given to each state 420 in a chart format.

Meanwhile, all tasks 410 in the state chart 430 have one object, whereas the coordinator 440 coordinates tasks 410 that have goals different from one another according to a user's intention or situation, thereby providing a variety of collaboration services.

In this regard, the user's intention or situation may be recognized by propagating an event E. That is, when the event E is input to the composite behavior 450, the composite behavior 450 backpropagates it to the coordinator 440 through the task 410. The coordinator 440 that received the event E recognizes the user's intention or situation based on the event, searches for the state 420 and task 410 corresponding to them from the state chart 430, and provide a collaboration service that meets the user's intention or situation by executing the composite behavior 450 given to the searched task 410.

As described above, a variety of low level events that were occurring in a lower behavior within the composite behavior 450 can be interpreted as high level events and transferred to the coordinator 440.

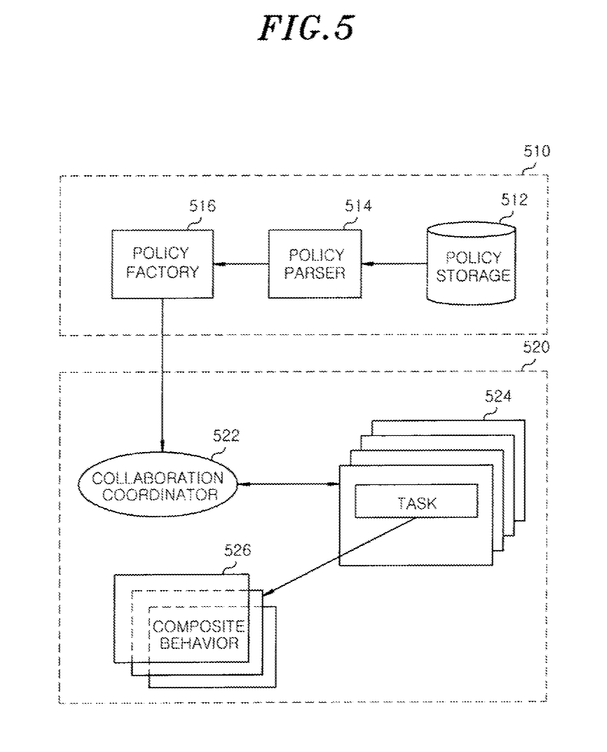

An apparatus for providing a collaboration service using a collaboration application having the structure described above will be described with reference to FIG. 5.

FIG. 5 is a block diagram of an apparatus for providing a collaboration service in accordance with an exemplary embodiment of the present invention. Referring to FIG. 5, the apparatus generally includes a collaboration management unit 510 and a collaboration execution unit 520.

The collaboration management unit 510 includes a policy storage 512, a policy parser 514 and a policy factory 516, and the collaboration execution unit 520 include a collaboration coordinator 522, a state chart 524, and a composite behavior factory 526.

The collaboration management unit 510 manages and stores a collaboration policy for a coordinator 522 in a collaboration application, that is, a collaboration coordinator. Herein, the collaboration policy may have the sole identifier for the collaboration coordinator 522 and may be constructed of task elements for collaboration services. The task element may be defined by combining composite behaviors of a tree structure sequentially or in parallel.

Such collaboration management unit 510 includes a policy storage 512 to store collaboration policies, a policy parser 514 to load the collaboration policies from the policy storage 512 and parse them, and a policy factory 516 to generate the collaboration coordinator 522 on the basis of the parsed collaboration policies and execute a collaboration application. Further, the collaboration coordinator 522 is generated using an identifier of a collaboration policy, and composite behavior of the task element in the collaboration policy is stored in the composite behavior factory 526 of the collaboration execution unit 520.

With the start of the collaboration application, the collaboration execution unit 520 gives one state every task to construct the state chart 524, and each task is given composite behavior existing in the composite behavior factory 526.

When such construction is finished, the collaboration application enters into an initial state in order to generate and execute a task suitable to the initial state.

As the task is executed, composite behavior given to the relevant task is executed. Accordingly, lower behaviors continue to be spread out in the composite behavior of the tree structure, thereby performing a collaboration service.

When an event is received during such performance as set for the above, the event is back-propagated and transferred to the collaboration coordinator 522, and the collaboration coordinator 522 determines a user's intention or situation based on the backpropagated event, stops existing tasks, and selects a new task in the state chart 530 to execute, thereby providing a variety of collaboration services that meet the user's intention and situation.

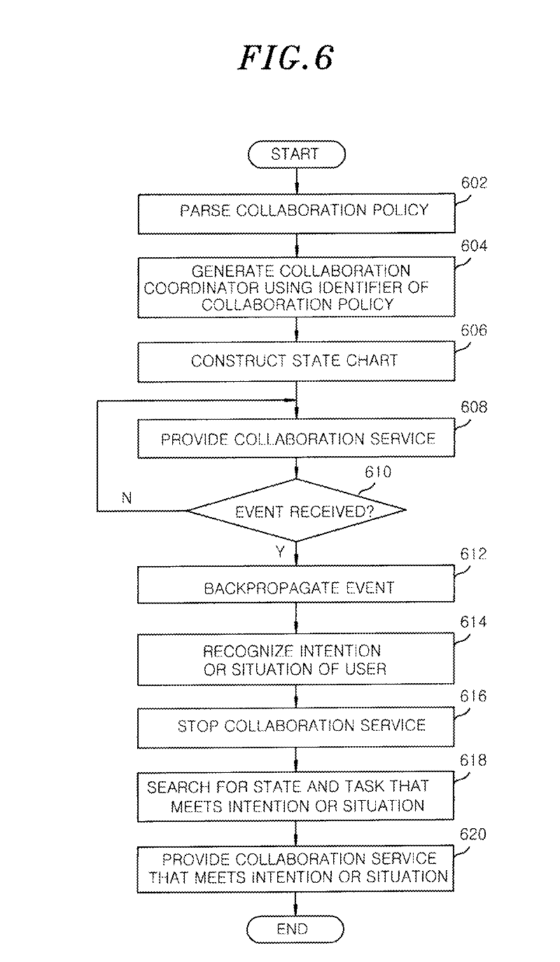

A process performed by the apparatus for providing a collaboration service described above will be described with reference to FIG. 6.

FIG. 6 is a flowchart illustrating a method for providing a collaboration service in accordance with an exemplary embodiment of the present invention.

Referring to FIG. 6, the policy parser 514 parses at least one of collaboration policies in a policy storage 512, which stores a plurality of collaboration policies whose task element is composite behavior of a tree structure, and provides a policy factory 516 with the parsed collaboration policies in operation 602. Here, the collaboration policy has an identifier for the collaboration coordinator 522.

Next, the policy factory 516 generates the collaboration coordinator 522 using the identifier of the parsed collaboration policies in operation 604, and the collaboration coordinator 522 builds up a state chart 524 in which a state is given to each task in operation 606.

Next, the collaboration coordinator 522 generates a task according to an initial state in the state chart 524 for the execution thereof. Further, the collaboration coordinator 522 searches composite behavior in a collaboration policy that is given to the task executed in the composite behavior factory 526. That is, the collaboration coordinator 522 executes the composite behavior associated with the executed task from the highest parent behavior to the lowest child behavior, thereby providing a collaboration service in operation 608.

When an event is received in arbitrary behavior within the composite behavior while being provided such a collaboration service, the arbitrary behavior backpropagates an event using event processing functions such as propagation, interpretation, aggregation, and filtering, and provides the same to the collaboration coordinator 522 in operation 612. As a result, the collaboration coordinator 522 recognizes the user's intention or situation by interpreting the event in operation 614.

The collaboration coordinator 522 stops the task of providing the collaboration service in operation 616, and then searches for a state and a new task that meet the recognised intention or situation in the state chart 524 in operation 618.

Next, the collaboration coordinator 522 provides a collaboration service that meets the user's intention or situation by executing composite behavior given to a new task in operation 620.

The apparatus and method for providing a collaboration service described above may be implanted to a service robot in a smart environment, thereby providing a variety of collaboration services that meet a user's situation through a high level collaboration model based on behavior (collaboration policy).

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for generating composite behavior for a collaboration service, the method comprising:
connecting unit behaviors in a tree structure to generate the composite behavior,
wherein each unit behavior in the composite behavior has an event processing functionality that propagates a received event to a child behavior and parent behavior in the tree structure.

2. The method of claim 1, wherein the event processing functionality comprises a filtering that does not propagate the event, an interpretation that interprets the event and aggregates the event to another type of event containing the aggregated result to propagate, or an aggregation that combines one or more events received and aggregates the received events into other type of event to propagate.

3. The method of claim 1, wherein the unit behaviors in the tree structure are configured to execute sequentially or simultaneously.

4. An apparatus for generating a collaboration application, the apparatus comprising:
a state chart configured to have tasks for a variety of states; and
a coordinator configured to provide a collaboration service using a collaboration application,
wherein the collaboration application comprises a task connected to composite behavior of a tree structure and a state to perform the tasks, the tree structure having a parent behavior and a child behavior on a basis of the state chart.

5. The apparatus of claim 4, wherein the coordinator is configured to receive events input to the composite behavior through the task connected to the composite behavior, thereby recognizing a user's intention or situation.

6. The apparatus of claim 5, wherein the coordinator is configured to search for a state in the state chart and a task corresponding to the state in accordance with the recognized intention or situation of the user, and connect the searched task to a composite behavior corresponding thereto.

7. An apparatus for providing a collaboration service, comprising:
a collaboration management unit configured to manage a plurality of collaboration policies whose task element is composite behavior of a tree structure and execute a collaboration application by parsing at least one of the plurality of collaboration policies; and
a collaboration execution unit configured to construct a state chart in which a state is given to each task when the collaboration application is executed, execute a task corresponding to the state in the state chart, and execute the composite behavior in the collaboration policy given to the task from parent behavior of the highest level to a child behavior of the lowest level, thereby providing the collaboration service.

8. The apparatus of claim 7, wherein the collaboration management unit comprises;
a policy storage that stores the plurality of collaboration policies having different identifiers;
a policy parser configured to load and parse at least one of collaboration policies stored in the policy storage; and
a policy factory configured to generate a collaboration coordinator for executing a collaboration application for the parsed collaboration policy based on the identifier of the parsed collaboration policy.

9. The apparatus of claim 8, wherein the collaboration coordinator constructs the state chart and recognizes a user's intention or situation by receiving an event that is input to the composite behavior through the task and state.

10. The apparatus of claim 9, wherein the collaboration coordinator is configured to stop the task that is being executed in accordance with the recognised user's intention or situation, search for a state and a task in the state chart, and execute the searched task.

11. The apparatus of claim 9, wherein the collaboration coordinator searches for a state and a task in the state chart in accordance with the user's intention or situation recognized, and executes composite behavior that is given to the searched task.
